(19) United States
(12) Patent Application Publication
(10) Pub. No.: US 2008/0046257 A1
(43) Pub. Date: Feb. 21, 2008

(54) METHOD OF REFLECTIVE AND INTERACTIVE RELATIONSHIP BUILDING

(76) Inventor: Al Sarno, Hannibal, MO (US)

Correspondence Address: Scott R. Kimsey;Sonnenschein Nath & Rosenthal LLP, Wacker Drive Station, Sears Tower, P.O. Box #061080, Chicago, IL, 60606-1080, US

(21) Appl. No.: 11/464,723

(22) Filed: Aug. 15, 2006

Related U.S. Application Data
(60) Provisional application No. 60/822,450, filed on Aug. 15, 2006.

(51) Int. Cl. G06Q 10/00; G06Q 30/00

(52) U.S. Cl. 705/1

(57) ABSTRACT

The present invention provides a method of building relationships between two or more people. In one aspect, the present invention includes the steps of a) identifying at least one group to which individual people belong; b) identifying two or more categories within the group, each of the individuals belonging to a different category; c) providing to each of the individuals an activity or task adapted to the differences associated with the category to which that individual belongs; and d) utilizing the activities from step c) to build relationships.

This application incorporates by reference U.S. Provisional Patent Application No. 60/822,450 filed Aug. 15, 2006 in its entirety.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright work rights whatsoever.

### FIELD OF THE INVENTION

The present invention relates generally to a method for facilitating the building of a long lasting, meaningful relationship between at least two people. Generally, the present invention relates to a process utilizing theories people in different and defined groups, such as, men and women, adults and children, a race, a religion, a generation, learn in different styles and relate to people of another groups differently, therefore this method teaches how to facilitate relationship building in ways that are meaningful and useful. More specifically, the present invention is concerned with providing materials to facilitate the relationship building process by using a unique system first identifying a person as belonging to a group, then providing different information to review and individualized tasks to complete separately based on that group and finally providing a time to compare and share with the other person(s) working on building the relationship. The individual tasks are reflective in nature and the comparison at the end of the time increases the individuals communication and awareness and helps to build a stronger relationship.

### BACKGROUND OF THE INVENTION

Societal problems tend to result from the breakdown of relationships. In today's society, most people have not been taught how to maintain relationships. Intimate relationships are fundamental to a functioning society. Relationships between at least two people be it a man and woman, husband and wife, or child and parent, can all benefit from relationship building.

Relationships that survive are the ones that enhance and foster the balance of individuality, interdependency, and intimacy. Individuality is what makes people unique and is necessary for people to thrive in a relationship. Relationships succeed when similarities are strengthened and differences are accepted, not magnified or ignored. Relationships that succeed build up the 80% commonalities we share and do not suppress or magnify the 20% differences that make us each individual. Individuality is a balance between the extremes of conformity and antisocial attitudes and behaviors.

Interdependency is the healthy goal of relationship. Dysfunctional styles of relating are known as dependency, codependency, and independency. Children should be raised to be interdependent not independent as is often said. Interdependency is the balance between dependency, codependency, and independency.

Intimacy is key to enjoying the relationships with God, ourselves, and others, including a partner, parent, child, sibling, or co-worker. Intimacy is a structured balance between the extremes of rigidity, shame, control and chaos, anarchy, and permissiveness. Both extremes are forms of intimidation, which is the opposite of intimacy. The four types of intimidation are passive, aggressive, passive-aggressive, and intimidation by default. Intimacy is relationally achieved in the quest for four components: (1) spending time together and relating, (2) self-disclosure and discovery, (3) compliment and complement and (4) enjoying the ultimate mystery of relationship in an atmosphere of humor and fun.

Traditionally, when there is a major breakdown in relationships, families, or partners, the individuals will go to a counselor, use a workbook, try a self-help book or just do nothing. Counselors charge by the hour and can be very expensive, and some people do not understand or appreciate how important a non-bias person can be. Often, people feel that counseling is a last resort rather than a preemptive one. Some people feel embarrassed to go to a counselor and go because the other person in the relationship forces them to go, and then when they do go they do not participate fully. This is a frustrating and ineffective situation for everyone.

In the workplace, intimidation and dysfunction are just as prevalent as in a familial setting. A breakdown in relationships occurring in the workplace can be damaging to not only the people involved but to the corporation as well. Often this dysfunction in office relationships is never addressed. Some corporations do try to preemptively solve relationship problems by team building. Traditionally, team building will involve a personality test for each team member. Often these personality tests makes a person give up a lot of themselves up front. These test often make a person can feel defensive or they will not want to participate because the test is too personal and they do not approach the test with an open mind. The personality test is not helpful if this occurs and the entire team building exercise wastes everyone's time. Also, if the point is to build up relationships in the workplace it will often result in the opposite because it will frustrate the participants or someone is incorrectly categorized and therefore incorrectly dealt with.

There are relational workbooks on the market, however these are generic and are not focused on the individual and on the need for individual time and reflection. One place that a breakdown in relationships is often seen is between a man and a woman. Often if a man and woman try to sit down together with a relational workbook the man often feels like the woman gives all the answers first. The man feels like an emotional idiot. The woman often feels like the man just sits there, not trying and not working at the relationship. Both individuals feel disconnected and do not have time with their own thoughts and feelings to ponder and figure out what is important to them. The same is true when there are more people. There will be some people participating and not. Again, this does nothing for strengthening relationships because no one is working individually to build themselves or working together to build the team.

There are many books written about relationships and how to communicate more effectively. The problem is that these books are generic. The worst and most unfortunate situation that occurs when a relationship breaks down is the situation where the individuals do nothing, nothing is resolved, and eventually the relationship dissolves.

The present inventions addresses the specific goals and services of the people in a relationship. The workbooks are reflective and interactive. The method of reflecting individually, using individually designed components and tasks, will establish a firm foundation or do reparative, structural work or both as needed by the participants.

### SUMMARY OF THE INVENTION

The present invention provides a method of building relationships between two or more people. In one aspect, the present invention includes the steps of a) identifying at least one group to which individual people belong; b) identifying two or more categories within the group, each of the individuals belonging to a different category; c) providing to each of the individuals an activity or task adapted to the differences associated with the category to which that individual belongs; and d) utilizing the activities from step c) to build relationships.

In another aspect, step c) of the present method further includes the steps of i) providing a first set time during which each individual reviews reflective information and completes tasks separately; ii) providing a second set time during which the individuals interact; and iii) providing a completion time by which all activities will be completed.

In still another aspect of the present invention, the individuals are involved in an intimate relationship.

In still another aspect of the present invention, the first set time is at least twelve hours long.

In still another aspect of the present invention the second set time is completed within at least twenty-four hours of the first set time.

In another aspect of the present invention, the completion time is from about thirty days to about forty-five days.

In another aspect of the present invention, the group is an identifiable classification of people wherein at least two people can be classified in two separate categories within the group.

In another aspect of the present invention, the group is one of gender, religion, nationality, race, social status, political philosophy, economic wealth, age, generation, personality, familial status, and birth order.

The foregoing and other objects are intended to be illustrative of the invention and are not meant in a limiting sense. Many possible embodiments of the invention may be made and will be readily evident upon a study of the following specification and accompanying drawings comprising a part thereof Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but rather as a basis for the claims and as a representative basis for teaching one skilled in the art to variously employ the present invention in virtually any appropriately detailed structure.

The present invention is rooted in the recognition of the inherent differences between two or more individuals within a group. These groups may be defined by virtually any criteria that differentiate one person from another. For example, groups may be defined by gender, religion, nationality, race, social status, political philosophy, economic wealth, age, generation, personality, familial status, birth order, and the like. Each group has different categories in which individuals within the group may be classified. For example, for gender, categories may be defined as male and female, or for birth order, categories may be defined as oldest child, middle child, and youngest child. When categorically different individuals within the group interact, the individuals' values, beliefs, and attitudes may be different enough that misunderstandings arise. That is, categorically different individuals within the group may interpret deeds and remarks of the other in ways other than they were intended, and vice versa. This is a fundamental problem in human relationships. The present invention is rooted in the fact that, when trying to build or repair relationships among people from different categories, these underlying differences in values, beliefs, and attitudes can hinder the relationship building process. The present invention provides a method to incorporate a recognition of these differences into the relationship-building process itself, thereby achieving more fully a building of the relationship between individuals both by minimizing misunderstandings due to differences among groups and by providing the individuals involved with a means of recognizing these differences and incorporating the differences into their own relationship-building skills.

At its heart, then, the present method builds or repairs relationships by first identifying at least one group. Having identified a group, categories in which to classify individuals involved in the relationship-building process are also identified. Having recognized the group and classified the categories, the present method next incorporates the step of preparing activities for two or more people in two or more disparate categories, the activities being directed to a common purpose but at the same time being tailored in their specifics to the differences inherent in the two groups. For example, in an embodiment of the present invention dealing with gender as a group, in which an individual will be classified as a man or a woman, the activity in question may involve a series of questions designed to reach a specific goal (e.g. determining what is important to the parties in the relationship). The activity is thus provided in two forms, one for men and one for women, both of which track each other in terms of the goal to be accomplished, and in some embodiments in large part track each other in terms of substance, but which at the same time incorporate differences purposefully contained within each activity in order to minimize misunderstandings or other problems due to differences between men and women. It should be noted that the word ‘activity,’ as used herein, is to be construed broadly to encompass any activity that may be undertaken by two or more individuals in order to build a relationship therebetween, such as, for example, reading, answering questions, problem solving, physical activities, and the like. Any suitable activity may be utilized in accordance with the present invention, provided that the activity is presented in at least two forms, each of the two forms containing differences that are related to the differences between the individuals involved in the relationship building.

Below are provided embodiments of the present method directed to relationship building between men and women. It should be noted, however, that the present method can be utilized with any two or more identifiable categories of people within a group. In the embodiments below, the differences in the activities provided by the present method are directed to eliminating misunderstanding between men and women and to providing an activity such that a man and a woman engaged in the activity will, by the differences in each of their versions of the activity, be “on the same page” in terms of their own subjective view of the activity, and their own subconscious and emotional response. The embodiments provided below are adapted to recognize and take advantage of inherent differences in men and women, and the activities are modified accordingly. In other embodiments, the activities may be adapted to take into account inherent differences between culture, where values may be quite different and where interpretations of the same act and/or statement may vary widely because of a cultural context, or inherent differences between races, social or economic status, and the like. In each of the embodiments, the underlying method remains the same and includes the steps of: 1) identifying a group and categories within that group to which the individuals to which the method is being applied belong; 2) providing to the two or more individuals at least one activity adapted in two or more versions, each version corresponding to the two or more categories involved, the activity being adapted to ensure that the two or more individuals are in essence performing the “same” activity and achieving the same ends by taking into account the inherent differences within the group and incorporating these into the multiple versions of the activity; and 3) utilizing the results of the activity to build relationships. As will be seen below, step 2 of the method may include multiple sub-steps, depending on the precise activity provided. For example, in some embodiments of the present method step 2 includes both a reflective and interactive portion, again keeping in mind the differences between the groups represented, in order to achieve an understanding between the two or more participants and build the relationship accordingly.

Embodiments of the invention, described below, provide a method for reflective and interactive relationship building. A preferred method utilizes the following steps, which shall be discussed below in further detail: 1) providing two individuals from different categories within a group; 2) providing a first set of time for each individual to review and reflect on the information and complete an activity provided therewith; and 3) providing a second set of time during which the participating individuals will interact. During the first set of time the individuals will each review and reflect upon the customized information separately (i.e. the version of the activity provided with that person's category in mind) and complete specific tasks provided for that individual. The first set of time is for the other individual to review and reflect upon the customized information related to that individual's category, and complete the tasks provided for that individual. At the end of the first set time the participating individuals will meet (second set of time), and interact together. In other embodiments, more than two individuals may be provided in step 1), in which case more first sets of time may be necessary, though it is preferred that all of the individuals come together and interact with one another during the second set of time.

In a preferred embodiment, the first set time and the second set time are completed in one day, with the entire process starting over at the beginning of every day until the completion of the entire program. In this embodiment, the entire program runs forty-five days, each day having a provided activity following the general principles outlined above. During the first set time each individual reviews the specific information provided for them and reflects on the changes that they want and need in the relationship. The individual then completes the tasks set forth in the activity. The tasks are there in order to provide a mechanism by which each individual may reflect on themselves and on the other individual. The tasks preferably focus on the individual and how they feel about themselves, the other individual, and/or the relationship the individual has with God. During the second set time the individuals come get together and discuss their separate reflections of the day. The time is spent working on sharing and listening to each other, drawing on the two different versions of the activity that they have each completed. The goal is that at the end of the time the individuals will have a better understanding of each other, and therefore a stronger relationship.

In the preferred embodiment of the present method, the individuals are male and female. FIGS. 1a and 1b illustrate a specific first set time for a male (FIG. 1a) and for a female (FIG. 1b). Specifically, the tasks that are to be completed are male-friendly and female friendly, or in other words the activity provided is provided in two forms, one version adapted specifically to inherent characteristics of the male, the other adapted specifically to inherent characteristics of the female. The male/female versions work with gender-specific learning and listening styles in order to maximize growth and response of each person and of the relationship.

Although illustrated herein as a relationship between a man and a women the method works for a variety of intimate or other interpersonal relationships, for example the relationship between a parent and child. Children (even grown ones) learn differently than parents because of the power position they occupy. Certain types of tasks can put a child on the defensive so the information and specific task is individualized for the type of role that a person has and the power position they are in, even if they are of the same gender. Likewise, in interpersonal relationships involving an employer and employee, inherent power differences must be taken into account when devising various versions of the activity or task to be provided.

In another preferred embodiment at least two individuals implement the present invention in order to build and strengthen the relationships of a team by strengthening and building the interpersonal relationships within that team. For example, a team could be located in the workplace or it may be a team that is sports related. In this embodiment individual team members are classified in categories through a series of fun and interactive techniques that are designed to classify the individuals without creating a defensive or poor attitude. Once each team member is classified in a category they receive different materials for that specific category. During the first set of time each team member reflects on the passages and completes any activities. The second set of time follows the first set of time and during the second set of time the team members interact. The goal of the second set of time is to have team members connect with each other but also to get a sense of the entire team and what strengths each team member brings to the team. In a workplace setting, this will help to increase the camaraderie and communications between coworkers making the team work and communicate more efficiently with each other.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of relationship building between two or more individuals comprising the steps of:
a) identifying at least one group to which said individuals belong;
b) identifying two or more categories of individuals belonging to the at least one group identified in step a), above;
c) providing to each of said individuals an activity adapted to the differences between the individuals that are associated with the category to which each individual belongs; and
d) utilizing said activities from step c), above, to build a relationship.

2. The method according to claim 1 wherein step c) further comprises the steps of:
i) providing a first set time, wherein said first set time is for each individual to review reflective information and complete tasks separately;
ii) providing a second set time, wherein said second set time is for the individuals to interact; and
iii) providing a completion time, wherein all activities will be completed within the completion time.

3. The method according to claim 2 wherein said individuals are in an intimate relationship.

4. The method according to claim 2 wherein said first set time is at least 12 hours long.

5. The method according to claim 2 wherein said second set time is completed within at least 24 hours of the first set time.

6. The method according to claim 2 wherein said completion time is approximately 30 to 45 days.

7. The method according to claim 2 wherein steps i) through iii) are interactively performed a predetermined number of times.

8. The method according to claim 2 wherein said group is an identifiable classification of people, wherein at least two people can be classified in two separate categories within that group.

9. The method according to claim 8 wherein said at least one group is selected from the group consisting of gender, religion, nationality, race, social status, political philosophy, economic wealth, age, generation, personality, familial status, and birth order.
